(19) United States
(12) Patent Application Publication
(10) Pub. No.: US 2024/0383628 A1
(43) Pub. Date: Nov. 21, 2024

(54) PACKAGING SYSTEM AND METHOD

(71) Applicant: Gert Frederick BLOM, Rustenburg (ZA)

(72) Inventor: Gert Frederick BLOM, Rustenburg (ZA)

(21) Appl. No.: 18/577,575

(22) PCT Filed: Jul. 8, 2022
(86) PCT No.: PCT/IB2022/056331

§ 371 Date: Jan. 8, 2024

(30) Foreign Application Priority Data
Jul. 8, 2021 (ZA) 2021/04765

(51) Int. Cl. B65B 25/00; A23B 5/015; A23L 3/28; B65B 7/28; B65B 55/08; B65B 55/16

(52) U.S. Cl. CPC B65B 25/001; A23B 5/015; A23L 3/28; B65B 7/2842; B65B 55/08; B65B 55/16

(57) ABSTRACT

This invention relates to a packaging system and method for packaging eggs (2). The packaging system comprises receiving means for receiving an egg. separation means (5) for breaking an egg (2) to separate egg content (7) from an eggshell of the egg, a container (6) for receiving the egg content (7) therein. radiation means for sterilising the container (6) with the egg content (7) therein, and scaling means for scaling the opening of the container.

### FIELD OF THE INVENTION

This invention relates to a packaging system and method, and more particularly, but not exclusively, to a packaging system and method for packaging eggs.

### BACKGROUND TO THE INVENTION

Eggs are sometimes deshelled and repackaged in plastic containers, sachets, or the like to produce “liquid eggs”. Each container may contain any number of eggs. Eggs whites, egg yolks, or a combination of egg whites and egg yolks are contained in the container. Liquid eggs are used in the food industry to allow for faster food preparation and less waste.

European patent application number EP2716162A1, entitled “Process for the preparation of liquid egg white” and filed in the names of Olivier Galet, Catherine Detre, and Valérie Breton (“Galet”) discloses a process for producing egg whites, the process comprising breaking an egg and recovering an egg white in a tank; inserting a predetermined amount of egg white in a package; tightly closing the package; pasteurizing the package by holding at a pasteurization temperature of 50-55 degrees Celsius for a period of 2-10 hours.

United States patent application number U.S. Pat. No. 8,778,429B2, entitled “Method for preparing egg products in a microwave oven” and filed in the name of Brad M. Halpern (“Halpern”), discloses an apparatus and method for preparing liquid egg products, for example pure egg whites, whole eggs and egg products either alone or mixed with spices, vegetables or other ingredients, in a microwave oven. The container for preparing the liquid egg products is relatively inexpensive and disposable. In another embodiment of the present invention, a method is provided for preparing liquid egg products in a disposable, microwavable container in which the liquid egg product expands while cooking and partially removes the lid of the container to create a delicious meal of properly cooked, fresh egg product, that are ready for consumption.

Halpern discloses the packaging of a raw egg in a microwaveable container and the subsequent cooking of the egg inside the container in a microwave oven. Halpern does not disclose storing a raw egg inside a container, decanting the raw egg, and then cooking the raw egg after it has been decanted.

German patent application number DE4421533A1, entitled “Packaged egg product comprising deshelled eggs in sealed plastic containers” and filed in the name of Georg Rothmaier (“Rothmaier”) discloses a packaged egg product in which a deshelled egg is packed and sealed in whole or in part within an air-tight plastic foil packaging and is then subjected to pasteurisation heat treatment before cooling and storage. During the pasteurisation heat treatment, the packaged egg mass is moved on a roller-guided seesaw device through a steam atmosphere above a water level, the temperature of the water being approximately 96° C. The duration of the heat treatment is approximately 10 minutes but can be shortened or lengthened depending on whether the finished egg mass should be more or less cooked. The packaged egg mass coagulates due to the heat treatment.

Galet and Rothmaier do not disclose processes for packaging and sterilizing eggs whilst the eggs remain in a raw state. Instead, the eggs are cooked during the sterilisation process.

### OBJECT OF THE INVENTION

It is an object of this invention to provide a packaging system and method which will, at least partially, alleviate some of the above-mentioned difficulties.

### SUMMARY OF THE INVENTION

In accordance with this invention there is provided a packaging system comprising receiving means for receiving an egg, separation means for breaking an egg to separate egg content from an eggshell of the egg, a container for receiving the egg content therein, radiation means for sterilising the container with the egg content therein, and sealing means for sealing the opening of the container.

There is provided for the receiving means to be a conveyer belt and/or conveyer rollers.

There is provided for the separation means to be suction cups.

There is provided for a high efficiency particulate air filter for filtering air whilst packaging the eggs.

There is provided for the egg content to be egg white and/or egg yolk and/or egg white and egg yolk.

There is provided for the egg content to be filled in a container to be content from any number of eggs.

There is further provided for the container to be a biodegradable plastic container.

There is further provided for the container to be a receptacle with an opening at an upper end thereof or a sachet or a bottle or the like.

There is provided for the sealing means to secure a closure over the opening of the container.

There is provided for the closure to be a cap or a foil or a sheet of plastics material.

There is provided for the radiation means to be an ultraviolet light.

There is provided for a cleaning means for cleaning the eggs.

There is provided for the cleaning means to be a brush.

There is provided for breakage means for breaking the eggshells into smaller pieces.

There is provided for the breakage means to be a crusher and/or a grinder.

There is provided for a drying means for drying the eggshells and/or eggshell pieces.

In accordance with this invention there is provided a packaging method comprising the steps of:
receiving an egg;
separating egg content from an egg shell of an egg;
filling a container with the egg content;
sterilising the container and egg content with radiation; and
sealing an opening of the container.

A further step of the invention provides for the egg to be at least partially cleaned with cleaning means.

A further step of the invention provides for the cleaning means to be a brush.

A further step of the invention provides for the egg to be moved from the cleaning means to the separation means for separating egg content from an eggshell of an egg with a conveyer belt and/or conveyer rollers.

A further step of the invention provides for air to be filtered with high efficiency particulate air filter during the packaging method.

A further step of the invention provides for the radiation means to be an ultraviolet light.

These and other features of the invention are described in more detail below.

### BRIEF DESCRIPTION OF THE DRAWINGS

One embodiment of the invention is described below, by way of example only, with reference to the drawings in which:

FIG. 1 shows a schematic diagram of a packaging method;

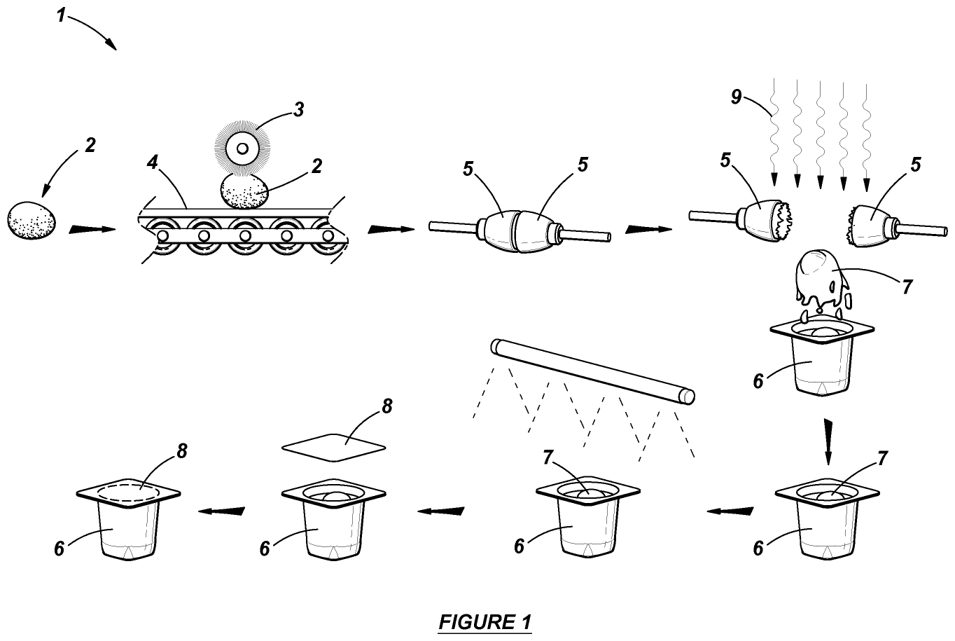

FIG. 2 shows a schematic diagram of a packaging method and eggshell processing process.

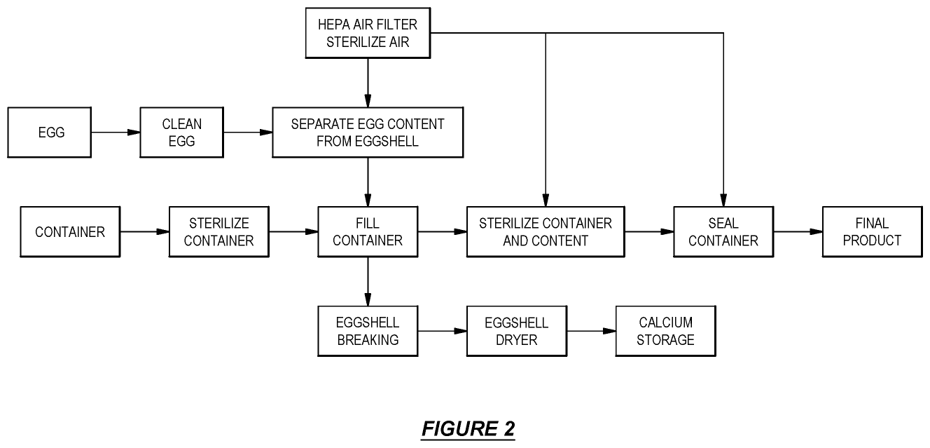

### DETAILED DESCRIPTION OF THE DRAWINGS

With reference to the drawings, a packaging process is indicated by reference numeral 1.

With regards to the packaging process 1, an egg 2 is received on conveyer rollers 4. The conveyer rollers 4 covey the egg 2 to a cleaner.

The cleaner has a roller brush 3. The roller brush 3 brushes an eggshell of the egg 2 to remove any dirt or other foreign material from the eggshell.

A high efficiency particulate air filter (“HEPA air filter”) 9 filters the air in the packaging system during the packaging method.

A second conveyer belt conveys a sterilised container 6 to underneath a separation means 5. The container 6 is a biodegradable plastic container with an opening at an upper end thereof.

The egg 2 is moved to the separation means 5. The separation means 5 are two opposing suction cups. Each suction cup 5 sucks or vacuum-attaches to a side of the egg 2. The suction cups 5 move away from each other to split the eggshell. Egg content 7 is thus separated from the eggshell. The container 6 is aligned with the egg content 7, in this case unseparated egg white and egg yolk. The container 6 is filled with the egg content 7.

The container 6 with the egg content 7 therein is conveyed to a radiation means. The radiation means is an ultraviolet light (“UV light”). The UV light sterilises the container and the egg content that is now inside the container 6.

The sterilised container 6 and egg content 7 is conveyed to a sealing means. The sealing means places a foil 8 over the opening of the container 6. A food grade adhesive is used to secure the foil to an upper edge of the container 6.

The sealed container is conveyed to a storage unit.

From the suction cups, the separated eggshells are conveyed to an eggshell breaking means. In this case, the eggshell breaking means is a crusher.

The crusher crushes the eggshells into small particles.

The eggshell particles are conveyed to an eggshell dryer. The eggshell dryer dries the eggshell particles. The dryer also sterilises the eggshell particles.

The dried eggshell particles are conveyed to a storage unit.

It is envisaged that the invention herein described will provide an improved alternative to natural eggs in their eggshells. The packages eggs will have a longer shelf life and more eggs can be packed per unit volume than what is possible with natural eggs. The packaged eggs will be easy to transport without the risk of eggshell breakage. The packaged egg can also be frozen within the package for later use if it cannot be consumed prior to the expiry date of the egg. Eggshells also do not go to waste and can be processed for calcium and other uses.

It will be appreciated by those skilled in the art that many other embodiments of the invention are possible without departing from the scope of the invention. For example, the container may be a sachet. The cleaner may also be a bath. Additives, for example, spices, may also be added to the egg content prior to sealing the container.

1. A packaging system comprising receiving means for receiving an egg, separation means for breaking an egg to separate egg content from an eggshell of the egg, a container for receiving the egg content therein, radiation means for sterilising the container with the egg content therein, and sealing means for sealing the opening of the container.

2. The packaging system as claimed in claim 1 in which the receiving means belong to are any of the group of: conveyer belts or conveyer rollers.

3. The packaging system as claimed in claim 1 in which the separation means are suction cups.

4. The packaging system as claimed in claim 1 in which a high efficiency particulate air filter filters air whilst packaging the eggs.

5. The packaging system as claimed in claim 1 in which the egg content belongs to any of the group of: egg white, egg yolk, or egg white and egg yolk.

6. The packaging system as claimed in claim 1 in which the egg content to be filled in a container is the content from any number of eggs.

7. The packaging system as claimed in claim 1 in which the container is a biodegradable plastic container.

8. The packaging system as claimed in claim 1 in which the container belongs to any of the group of: a receptacle with an opening at an upper end thereof, a sachet, or a bottle.

9. The packaging system as claimed in claim 1 in which the sealing means secure a closure over the opening of the container.

10. The packaging system as claimed in claim 1 in which the closure belongs to any of the group of: a cap, a foil, or a sheet of plastics material.

11. The packaging system as claimed in claim 1 in which the radiation means are ultraviolet light.

12. The packaging system as claimed in claim 1 in which cleaning means are used for cleaning the eggs.

13. The packaging system as claimed in claim 12 in which the cleaning means is a brush.

14. The packaging system as claimed in claim 1 in which breakage means are used for breaking the eggshells into smaller pieces.

15. The packaging system as claimed in claim 12 in which the breakage means belongs to any of the group of: a crusher, or a grinder.

16. The packaging system as claimed in claim 1 in which drying means are used for drying the eggshells after separation.

17. A packaging method comprising the steps of:
receiving an egg;
separating egg content from an egg shell of an egg;
filling a container with the egg content;
sterilising the container and egg content with radiation; and
sealing an opening of the container.

18. The packaging method as claimed in claim 17 in which the egg is at least partially cleaned with cleaning means.

19. The packaging method as claimed in claim 17 in which the cleaning means is a brush.

20. The packaging method as claimed in claim 17 in which the egg is moved from the cleaning means to the separation means for separating egg content from an eggshell of an egg with a conveyer belt and/or conveyer rollers.

21-22. (canceled)
